(19) United States
(12) Patent Application Publication
(10) Pub. No.: US 2006/0222122 A1
(43) Pub. Date: Oct. 5, 2006

(54) Method for implementing diversity in mobile telephone and mobile telephone incorporating the same

(75) Inventors: Jin-Woo Jung, Seoul (KR); Hong-Woo Lee, Seongnam-si (KR)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignees: Pantech Co., Ltd.; SK Telecom Co., Ltd.

(21) Appl. No.: 11/393,390

(22) Filed: Mar. 30, 2006

(30) Foreign Application Priority Data
Apr. 15, 2005 (KR) 2005-31594
Mar. 31, 2005 (KR) 10-2005-0026863

(51) Int. Cl. H04L 1/02

(52) U.S. Cl. 375/347

(57) ABSTRACT

Disclosed herein is a diversity method for activating or deactivating a diversity function depending on the amount of power remaining in a power supply device and a mobile communication terminal incorporating the same. In an embodiment of the present invention, when the amount of power remaining in a power supply device is smaller than a reference value for the activation of a transmission/reception diversity function, which has been previously stored in memory, the transmission/reception diversity function is deactivated, and when the amount of power remaining in a power supply device is equal to or larger than the reference value, the transmission/reception diversity function is activated. In another embodiment, when the amount of power remaining in a power supply device is smaller than a reference value for the activation of a transmission or reception diversity function, which has been previously stored in memory, the transmission or reception diversity function is deactivated.

### BACKGROUND OF THE INVENTION

1. Field of the Invention

The present invention relates generally to a method of implementing diversity in a mobile telephone and a mobile telephone incorporating the same and, more particularly, to a diversity method for activating or deactivating a diversity function depending on the amount of power remaining in a power supply device and a mobile communication terminal incorporating the same.

2. Description of the Related Art

A mobile communication system is generally constructed such that multiple mobile communication terminals communicate with each other through a base station. However, in such a mobile communication system, during the transmission of signals, signals received through different paths are randomly offset due to various causes, such as the distance between a transmitter and a receiver, frequency used, and the reflection, diffraction and scattering of radio waves, so that the distortion of received signals is caused by a fading phenomenon, in which the reception strength thereof decreases.

Since the fading phenomenon causes the amplitude of received signals to decrease by several decibels to several tens of decibels, the received signals distorted by the fading phenomenon cause the error of transmission data transmitted by a transmitter if they are not appropriately processed upon data demodulation, thereby degrading the quality of mobile communication services.

Therefore, the fading phenomenon must be overcome to transmit signals without degradation of quality in a mobile communications system. Various diversity methods are used to overcome such fading phenomenon.

A diversity scheme is a method of using a plurality of antennas in which, when the magnitude of a signal received through one antenna decreases due to a fading phenomenon, transmission signals are received through a secondary antenna, and the transmission signals are demodulated.

In a conventional mobile communications terminal to which a transmission/reception diversity method is applied the diversity transmission/reception method is implemented by including a plurality of transmission/reception units, each of which includes an antenna, a duplexer for separating RF transmission signals and RF reception signals, an RF reception unit for receiving RF signals from a base station, and an RF transmission unit for transmitting RF signals. In the conventional mobile communication terminal, it is impossible to selectively turn on or off a transmission/reception diversity function.

As a result, a mobile communication terminal to which a conventional transmission/reception diversity method is applied is constantly using a transmission/reception diversity function, so that power is applied to all of the RF transmission/reception units, and, thus, a problem occurs in that current consumption increases.

Furthermore, a mobile communication terminal to which a conventional transmission diversity method is applied also cannot selectively turn on or off a transmission diversity function, so that power is applied to all of the RF transmission units, and, thus, a problem occurs in that current consumption increases. Similarly, a mobile communication terminal to which a conventional reception diversity method is applied also cannot selectively turn on or off a reception diversity function, so that power is applied to all of RF reception units, and, thus, a problem occurs in that current consumption increases.

### SUMMARY OF THE INVENTION

Accordingly, the present invention has been made keeping in mind the above problems occurring in the prior art, and an object of the present invention is to provide a transmission/reception diversity method of controlling whether to activate a transmission/reception function depending on the amount of power remaining in a power supply device, and a mobile communication terminal incorporating the same.

Another object of the present invention is to provide a transmission diversity method of controlling whether to activate a transmission function depending on the amount of power remaining in a power supply device, and a mobile communication terminal incorporating the same.

Furthermore, another object of the present invention is to provide a reception diversity method of controlling whether to activate a reception function depending on the amount of power remaining in a power supply device, and a mobile communication terminal incorporating the same.

In order to accomplish the above object, the present invention includes a first step of determining whether an amount of power remaining in a power supply device is smaller than a reference value for activation of a transmission/reception diversity function previously stored in memory; and a second step of deactivating the transmission/reception diversity function if the amount of power remaining in a power supply device is smaller than the reference value, and activating the transmission/reception diversity function if the amount of power remaining in a power supply device is equal to or larger than the reference value.

Preferably, the deactivation of the transmission/reception diversity function may be performed by applying power to one of Radio Frequency (RF) transmission/reception units and cutting off supply of power to at least one remaining transmission/reception unit, and the activation of the transmission/reception diversity function at the second step may be performed by applying power to all of RF transmission/reception units.

Furthermore, when a user requests the activation of the transmission/reception diversity function, the transmission/reception diversity function may be activated regardless of the amount of power remaining in the power supply device, and when the user requests the deactivation of transmission/reception diversity function, the transmission/reception diversity function may be deactivated.

Furthermore, the present invention includes a first step of determining whether an amount of power remaining in a power supply device is smaller than a reference value for activation of a transmission diversity function previously stored in memory; and a second step of deactivating the transmission diversity function if the amount of power remaining in a power supply device is smaller than the reference value, and activating the transmission diversity function if the amount of power remaining in a power supply device is equal to or larger than the reference value.

Preferably, the deactivation of the transmission diversity function at the second step may be performed by applying power to one of RF transmission units and cutting off supply of power to at least one remaining transmission unit, and the activation of the transmission diversity function at the second step may be performed by applying power to all of RF transmission units.

Furthermore, when a user requests the activation of the transmission diversity function, the transmission diversity function may be activated regardless of the amount of power remaining in the power supply device, and when the user requests the deactivation of transmission diversity function, the transmission diversity function may be deactivated.

Furthermore, the present invention includes a first step of determining whether an amount of power remaining in a power supply device is smaller than a reference value for activation of a reception diversity function previously stored in memory; and a second step of deactivating the reception diversity function if the amount of power remaining in a power supply device is smaller than the reference value, and activating the reception diversity function if the amount of power remaining in a power supply device is equal to or larger than the reference value.

Preferably, the deactivation of the reception diversity function at the second step may be performed by applying power to one of RF reception units and cutting off supply of power to at least one remaining reception unit, and the activation of the reception diversity function at the second step may be performed by applying power to all of RF reception units.

Furthermore, when a user requests the activation of the transmission/reception diversity function, the transmission/reception diversity function may be activated regardless of the amount of power remaining in the power supply device, and when the user requests the deactivation of transmission/reception diversity function, the transmission/reception diversity function may be deactivated.

Furthermore, the present invention includes a memory unit for storing a reference value of an amount of power remaining in a power supply device for activation of a transmission/reception diversity function; a plurality of RF transmission/reception units each including an antenna, a duplexer for separating RF transmission signals and RF reception signals, an RF reception unit for receiving RF signals from a base station, and an RF transmission unit for transmitting RF signals; a control unit for deactivating a transmission/reception diversity function when an amount of power remaining in a power supply device is smaller than the reference value stored in the memory unit, and activating the transmission/reception diversity function when the amount of power remaining in the power supply device is equal to or larger than the reference value stored in the memory; and a transmission/reception diversity control unit for applying power to all of the RF transmission/reception units when the activation of the transmission/reception diversity function is requested by the control unit, and applying power to one of the RF transmission/reception units and cutting off supply of power to at least one remaining RF transmission/reception unit when the deactivation of the transmission/reception diversity function is requested by the control unit.

Furthermore, the present invention includes a memory unit for storing a reference value of an amount of power remaining in a power supply device for activation of a transmission diversity function; an RF reception unit for receiving RF signals from a base station; a plurality of RF transmission units for transmitting RF signals; a control unit for deactivating a transmission diversity function when an amount of power remaining in a power supply device is smaller than the reference value stored in the memory unit, and activating the transmission diversity function when the amount of power remaining in the power supply device is equal to or larger than the reference value stored in the memory; and a transmission diversity control unit for applying power to all of the RF transmission units when the activation of the transmission diversity function is requested by the control unit, and applying power to one of the RF transmission units and cutting off supply of power to at least one remaining RF transmission unit when the deactivation of the transmission diversity function is requested by the control unit.

Furthermore, the present invention includes a memory unit for storing a reference value of an amount of power remaining in a power supply device for activation of a reception diversity function; a plurality of RF reception units for receiving RF signals from a base station; an RF transmission unit for transmitting RF signals; a control unit for deactivating a reception diversity function when an amount of power remaining in a power supply device is smaller than the reference value stored in the memory unit, and activating the reception diversity function when the amount of power remaining in the power supply device is equal to or larger than the reference value stored in the memory; and a reception diversity control unit for applying power to all of the RF reception units when the activation of the reception diversity function is requested by the control unit, and applying power to one of the RF reception units and cutting off supply of power to at least one remaining RF reception unit when the deactivation of the reception diversity function is requested by the control unit.

### BRIEF DESCRIPTION OF THE DRAWINGS

The above and other objects, features and advantages of the present invention will be more clearly understood from the following detailed description taken in conjunction with the accompanying drawings, in which:

FIG. 1A is a diagram illustrating the internal construction of a mobile communication terminal related to a transmission/reception diversity function according to an embodiment of the present invention;

FIG. 1B is a diagram illustrating the internal construction of a mobile communication related to a transmission diversity function according to another embodiment of the present invention;

FIG. 1C is a diagram illustrating the internal construction of a mobile communication related to a reception diversity function according to still another embodiment of the present invention; and

FIG. 2 is a flowchart illustrating a process of controlling a diversity function according to an embodiment of the present invention.

### DESCRIPTION OF THE PREFERRED EMBODIMENTS

Reference now should be made to the drawings, in which the same reference numerals are used throughout the different drawings to designate the same or similar components.

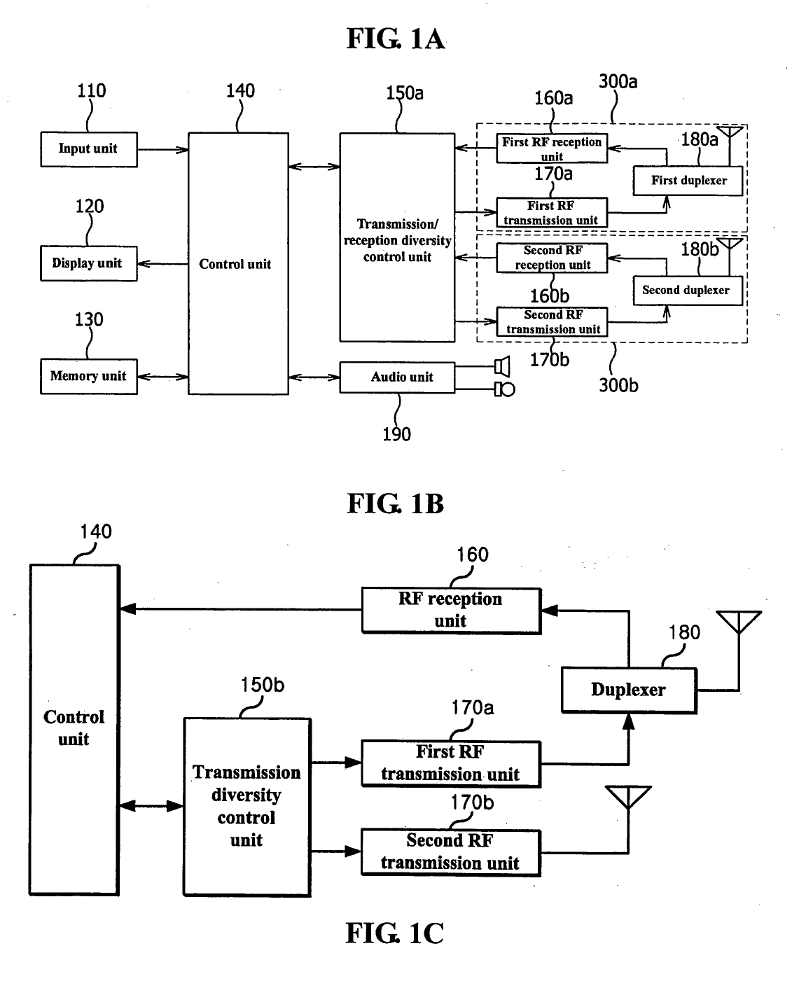

FIG. 1A is a diagram illustrating the internal construction of a mobile communication terminal related to a transmission/reception diversity function according to an embodiment of the present invention.

As illustrated in FIG. 1A, the mobile communication terminal according to the present invention includes an input unit 110, a display unit 120, a memory unit 130, a control unit 140, a transmission/reception diversity control unit 105a, a plurality of RF transmission/reception units 300a and 300b, and an audio unit 190. Particularly, FIG. 1A illustrates the embodiment of the internal construction of the mobile communication terminal having two RF transmission/reception units or two RF transmission/reception paths.

The input unit 110 can be implemented using one of various devices, such as a keypad or a touch screen, and is used when a user selects a desired function or inputs information.

The display unit 120 displays the state and operational status of the mobile communication terminal.

The memory unit 130 stores programs and data required for the control of the state and operation of the mobile communication terminal, and can be implemented using one of various devices, such as Erasable Programmable Read Only Memory (EPROM), Static Random Access Memory (SRAM) or flash memory. Particularly, the memory unit 130 in the present invention stores a reference value for the amount of power remaining in a power supply device for the activation of a transmission/reception diversity function.

The control unit 140 controls the entire state and operation of the mobile communication terminal, and can be implemented using a microprocessor or a Digital Signal Processor. Particularly, in the present invention, the control unit 140 deactivates the transmission/reception diversity function when the amount of power remaining in a power supply device is smaller than the reference value for the activation of the transmission/reception diversity function, which is stored in the memory unit, and activates the transmission/reception diversity function when the amount of power remaining in the power supply device is equal to and larger than the reference value for the activation of the transmission/reception diversity function, which is stored in the memory. Furthermore, the control unit 140 activates the transmission/reception diversity function regardless of the amount of power remaining in the power supply device when a user requests the activation of the transmission/reception diversity function, and deactivates the transmission/reception diversity function when the user requests the deactivation of the transmission/reception diversity function. Preferably, the power supply device is a battery.

The transmission/reception diversity control unit 150a applies power to all of the RF transmission/reception units when the activation of the transmission/reception diversity function is requested by the control unit 140, and applies power to one of the RF transmission/reception units and cuts off supply of power to the remaining RF transmission/reception units when the deactivation of the transmission/reception diversity function is requested by the control unit 140. An example in which two RF transmission/reception units exist is illustrated in FIG. 1A. That is, when the transmission/reception diversity function is activated, power is applied to both a first RF transmission/reception unit 300a and a second RF transmission/reception unit 300b, thereby allowing the two RF transmission/reception units to be used. In contrast, when the transmission/reception diversity function is deactivated, power is applied to one of the two RF transmission/reception units.

The first RF transmission/reception unit 300a includes an antenna, a first duplexer 180a for separating RF transmission signals and RF reception signals, a first RF reception unit 160a for receiving RF signals from a base station, and a first RF transmission unit 170a for transmitting RF signals. The second RF transmission/reception unit 300b also includes the same units as the first RF transmission/reception unit 300a. That is, the second RF transmission/reception unit 300b includes an antenna, a second duplexer 180b, a second RF reception unit 160b and a second RF transmission unit 170b.

The audio unit 190 functions to process a user's voice signals received through a microphone MIC into a form suitable for transmission, and to process a called/calling party's voice signals or various types of audio signals generated at the control unit 140 into a form to be output through a speaker SPK.

Next, a process of controlling a transmission diversity function according to the present invention is described with reference to FIG. 1B.

FIG. 1B is a diagram illustrating the internal construction of a mobile communication related to a transmission diversity function according to another embodiment of the present invention.

The mobile communication terminal according to the present invention also includes an input unit (not shown), a display unit (not shown), a memory unit (not shown), and an audio transformation unit (not shown), as shown in FIG. 1A, and the functions thereof are the same, so that illustrations and descriptions thereof are omitted here.

The control unit 140 activates a transmission diversity function when the amount of power remaining in a power supply device is smaller than a reference value for the activation of the transmission diversity function, which has been previously stored in the memory unit, and deactivates the transmission diversity function when the amount of power remaining in the power supply device is equal to or larger than the reference value for the activation of the transmission diversity function, which has been previously stored in the memory unit. Furthermore the control unit 140 according to the present invention activates the transmission diversity function regardless of the amount of power remaining in the power supply device when a user requests the activation of the transmission diversity function, and deactivates the transmission diversity function when the user requests the deactivation of transmission diversity function.

The transmission diversity control unit 150b applies power to all of the RF transmission units when the activation of the transmission diversity function is requested by the control unit 140, and applies power to one of the RF transmission units and cuts off supply of power to the remaining RF transmission units when the deactivation of the transmission diversity function is requested by the control unit 140. An example in which two RF transmission units exist is illustrated in FIG. 1B. That is, when the transmission diversity function is activated, power is applied to both a first RF transmission unit 170a and a second RF transmission unit 170b, thereby allowing the two RF transmission units to be used. In contrast, when the transmission diversity function is deactivated, power is applied to one of the two RF transmission units.

The RF reception unit 160 is a circuit for receiving RF signals from a base station. FIG. 1B illustrates a case in which only one reception path exists, that is, a reception diversity function is not applied, unlike the embodiment of FIG. 1A. The duplexer 180 functions to separate RF transmission signals and RF reception signals.

Next, a process of controlling a reception diversity function according to the present invention is described with reference to FIG. 1C.

FIG. 1C is a diagram illustrating the internal construction of a mobile communication terminal related to a reception diversity function according to still another embodiment of the present invention.

The mobile communication terminal according to the present invention also includes an input unit (not shown), a display unit (not shown), a memory unit (not shown), and an audio transformation unit (not shown), as shown in FIG. 1A, and the functions thereof are the same, so that illustrations and descriptions thereof are omitted here.

The control unit 140 activates the reception diversity function when the amount of power remaining in a power supply device is smaller than a reference value for the activation of the reception diversity function, which has been previously stored in the memory unit, and deactivates the reception diversity function when the amount of power remaining in the power supply device is equal to or lager than the reference value for the activation of the reception diversity function, which has been previously stored in the memory unit. Furthermore, the control unit 140 according to the present invention activates the reception diversity function regardless of the amount of power remaining in the power supply device when a user requests the activation of the reception diversity function, and deactivates the reception diversity function when the user requests the deactivation of the reception diversity function.

The reception diversity control unit 150c applies power to all of the RF reception units when the activation of the reception diversity function is requested by the control unit 140, and applies power to one of the RF reception units and cuts off supply of power to the remaining RF reception units when the deactivation of the reception diversity function is requested by the control unit 140. An example in which two RF reception units exist is illustrated in FIG. 1C. That is, when the reception diversity function is activated, power is applied to both a first RF reception unit 160a and a second RF reception unit 160b, thereby allowing the two RF reception units to be used. In contrast, when the reception diversity function is deactivated, power is applied to one of the two RF reception units.

The RF reception unit 160 is a circuit for receiving RF signals from a base station. FIG. 1C illustrates a case in which only one transmission path exists, that is, a transmission diversity function is not applied, unlike the embodiment of FIG. 1A. The duplexer 180 functions to separate RF transmission signals and RF reception signals.

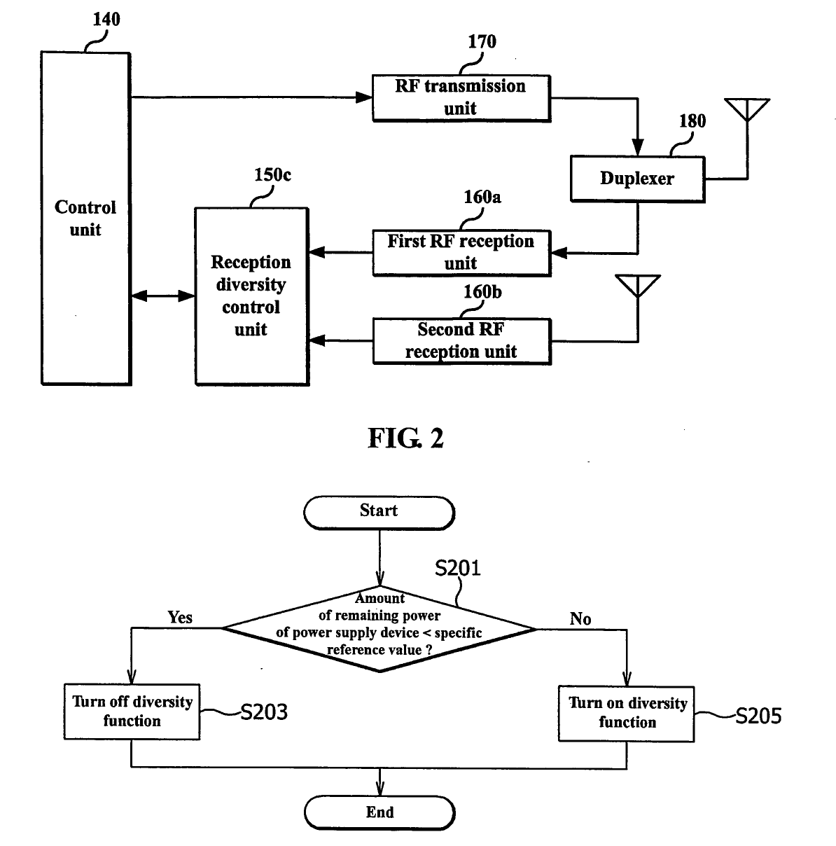

Next, a process of controlling diversity according to the present invention is described with reference to FIG. 2.

FIG. 2 is a flowchart illustrating a process of controlling diversity according to an embodiment of the present invention.

First, whether the amount of power remaining in a power supply device is smaller than a reference value is determined at step S201. The reference value is a reference value for the amount of power remaining in the power supply device for the activation of a diversity function, and has been previously stored in memory. Preferably, the power supply device is a battery.

If, as a result of the determination, the amount of power remaining in the power supply device is smaller than the reference value (YES at step S201), the diversity function is turned off at step S203.

The diversity uses multiple antennas in which, when the magnitude of signals, having been transmitted using one antenna, decreases due to a fading phenomenon, signals transmitted through the remaining antennas are received and the transmitted signals are demodulated.

In order to apply such a diversity function to both transmission and reception units, RF transmission/reception units are additionally required, in addition to a conventional RF transmission/reception unit existing in a mobile communication terminal. That is, a mobile communication terminal must be additionally equipped with an RF transmission/reception unit including an antenna, a duplexer, an RF transmission unit, and an RF reception unit. Meanwhile, there is a case in which only a reception diversity function is applied or only a transmission diversity function is applied.

Conventionally, transmission/reception functions are implemented in a terminal by including an additional RF transmission/reception unit. However, the setting and release of transmission/reception diversity functions are impossible. Therefore, a plurality of RF transmission/reception units each including an antenna, a duplexer, an RF transmission unit and an RF reception unit always operates, so that there is a problem of current consumption.

As a result, in order to resolve the above problem, the present invention checks the amount of power remaining in a power supply device, and, if the amount of power remaining is smaller than a reference value, releases transmission/reception diversity functions (transmission or reception diversity function depending on embodiments), thus preventing current consumption. That is, when the amount of power remaining is smaller than a specific value, power is supplied to only one RF transmission/reception unit, and the supply of power to other RF transmission/reception units is cut off, thereby preventing power consumption.

Furthermore, the present invention can turn off only transmission diversity or only reception diversity. That is, it is possible to separately control only transmission diversity or reception diversity.

In other words, the present invention applies power to only one RF transmission unit and cuts off the supply of power to other transmission RF units to control only a transmission diversity function when the amount of power remaining in a power supply device is smaller than a reference value for the activation of transmission diversity, which has previously been stored in memory.

Furthermore, the present invention applies power to only one RF reception unit and cuts off the supply of power to other reception RF units to control only a reception diversity function when the amount of power remaining in a power supply device is smaller than a reference value for the activation of reception diversity, which has previously been stored in memory.

Meanwhile, if, as a result of the determination at step S201, the amount of power remaining in a power supply device is equal to or larger than the reference value, a diversity function is activated, so that power is supplied to all of the RF transmission/reception units.

Furthermore, similarly, when the amount of power remaining in a battery is equal to or larger than a reference value of the amount of power remaining in a battery for the activation of transmission diversity, which has been previously stored in memory, power is supplied to all of RF transmission units. When the amount of power remaining in a battery is equal to or larger than a reference value of the amount of power remaining in a battery for the activation of reception diversity, which has been previously stored in memory, power is supplied to all of the RF reception units.

That is, it is possible not only to simultaneously control transmission/reception diversity functions, but also to turn on or off only a transmission or reception diversity function.

Accordingly, the mobile communication terminal to which a diversity function according to the present invention is applied continues to maintain diversity, and then, turns off the diversity function to prevent current consumption only when the amount of power remaining in a power supply device is equal to or larger than a reference value of the amount of power remaining in a battery.

As described above, the present invention provides a diversity method and a mobile communication terminal incorporating the same. The present invention controls whether to activate a diversity function depending on the amount of power remaining in a power supply device, thereby decreasing current consumption, so that there is an advantage in that the call waiting time of a mobile communication terminal increases.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of implementing diversity in a mobile communication terminal, comprising steps of:
determining whether an amount of power remaining in a power supply device is smaller than a reference value for activation of a transmission/reception diversity function previously stored in memory; and
deactivating the transmission/reception diversity function if the amount of power remaining in a power supply device is smaller than the reference value, and activating the transmission/reception diversity function if the amount of power remaining in a power supply device is equal to or larger than the reference value.

2. The method as set forth in claim 1, wherein the deactivation of the transmission/reception diversity function at the second step is performed by applying power to one of Radio Frequency (RF) transmission/reception units and cutting off supply of power to at least one remaining transmission/reception unit.

3. The method as set forth in claim 1, wherein the activation of the transmission/reception diversity function at the second step is performed by applying power to all of RF transmission/reception units.

4. The method as set forth in claim 1 wherein, when a user requests the activation of the transmission/reception diversity function, the transmission/reception diversity function is activated regardless of the amount of power remaining in the power supply device, and when the user requests the deactivation of transmission/reception diversity function, the transmission/reception diversity function is deactivated.

5. A method of implementing diversity in a mobile communication terminal, comprising steps of:
determining whether an amount of power remaining in a power supply device is smaller than a reference value for activation of a transmission diversity function previously stored in memory; and
deactivating the transmission diversity function if the amount of power remaining in a power supply device is smaller than the reference value, and activating the transmission diversity function if the amount of power remaining in a power supply device is equal to or larger than the reference value.

6. The method as set forth in claim 5, wherein the deactivation of the transmission diversity function at the second step is performed by applying power to one of RF transmission units and cutting off supply of power to at least one remaining transmission unit.

7. The method as set forth in claim 5, wherein the activation of the transmission diversity function at the second step is performed by applying power to all of RF transmission units.

8. The method as set forth in claim 5 wherein, when a user requests the activation of the transmission diversity function, the transmission diversity function is activated regardless of the amount of power remaining in the power supply device, and when the user requests the deactivation of transmission diversity function, the transmission diversity function is deactivated.

9. A method of implementing diversity in a mobile communication terminal, comprising steps of:
determining whether an amount of power remaining in a power supply device is smaller than a reference value for activation of a reception diversity function previously stored in memory; and
deactivating the reception diversity function if the amount of power remaining in a power supply device is smaller than the reference value, and activating the reception diversity function if the amount of power remaining in a power supply device is equal to or larger than the reference value.

10. The method as set forth in claim 9, wherein the deactivation of the reception diversity function at the second step is performed by applying power to one of RF reception units and cutting off supply of power to at least one remaining reception unit.

11. The method as set forth in claim 9, wherein the activation of the reception diversity function at the second step is performed by applying power to all of RF reception units.

12. The method as set forth in claim 9 wherein, when a user requests the activation of the reception diversity function, the reception diversity function is activated regardless of the amount of power remaining in the power supply device, and when the user requests the deactivation of reception diversity function, the reception diversity function is deactivated.

13. A mobile communication terminal, comprising:
a memory unit for storing a reference value of an amount of power remaining in a power supply device for activation of a transmission/reception diversity function;
a plurality of RF transmission/reception units each including an antenna, a duplexer for separating RF transmission signals and RF reception signals, an RF reception unit for receiving RF signals from a base station, and an RF transmission unit for transmitting RF signals;
a control unit for deactivating a transmission/reception diversity function when an amount of power remaining in a power supply device is smaller than the reference value stored in the memory unit, and activating the transmission/reception diversity function when the amount of power remaining in the power supply device is equal to or larger than the reference value stored in the memory; and
a transmission/reception diversity control unit for applying power to all of the RF transmission/reception units when the activation of the transmission/reception diversity function is requested by the control unit, and applying power to one of the RF transmission/reception units and cutting off supply of power to at least one remaining RF transmission/reception unit when the deactivation of the transmission/reception diversity function is requested by the control unit.

14. The mobile communication terminal as set forth in claim 13, wherein the power supply device is a battery.

15. A mobile communication terminal, comprising:
a memory unit for storing a reference value of an amount of power remaining in a power supply device for activation of a transmission diversity function;
an RF reception unit for receiving RF signals from a base station;
a plurality of RF transmission units for transmitting RF signals;
a control unit for deactivating a transmission diversity function when an amount of power remaining in a power supply device is smaller than the reference value stored in the memory unit, and activating the transmission diversity function when the amount of power remaining in the power supply device is equal to or larger than the reference value stored in the memory; and
a transmission diversity control unit for applying power to all of the RF transmission units when the activation of the transmission diversity function is requested by the control unit, and applying power to one of the RF transmission units and cutting off supply of power to at least one remaining RF transmission unit when the deactivation of the transmission diversity function is requested by the control unit.

16. The mobile communication terminal as set forth in claim 15, wherein the power supply device is a battery.

17. A mobile communication terminal, comprising:
a memory unit for storing a reference value of an amount of power remaining in a power supply device for activation of a reception diversity function;
a plurality of RF reception units for receiving RF signals from a base station;
an RF transmission unit for transmitting RF signals;
a control unit for deactivating a reception diversity function when an amount of power remaining in a power supply device is smaller than the reference value stored in the memory unit, and activating the reception diversity function when the amount of power remaining in the power supply device is equal to or larger than the reference value stored in the memory; and
a reception diversity control unit for applying power to all of the RF reception units when the activation of the reception diversity function is requested by the control unit, and applying power to one of the RF reception units and cutting off supply of power to at least one remaining RF reception unit when the deactivation of the reception diversity function is requested by the control unit.

18. The mobile communication terminal as set forth in claim 17, wherein the power supply device is a battery.
